(19) United States
(12) Patent Application Publication
(10) Pub. No.: US 2015/0044636 A1
(43) Pub. Date: Feb. 12, 2015

(54) BIOCOMPATIBLE MATERIAL BARS APT TO PREVENT THE INTERDENTAL BONE PEAK RESORPTION FOLLOWING DENTAL PROCEDURES AND / OR PERIODONTAL DISEASES

(71) Applicant: Jacopo Castelnuovo, Roma (IT)

(72) Inventor: Jacopo Castelnuovo, Roma (IT)

(21) Appl. No.: 14/371,284

(22) PCT Filed: Jan. 16, 2013
(86) PCT No.: PCT/IT2013/000013

§ 371 Date: Jul. 9, 2014

(30) Foreign Application Priority Data
Jan. 18, 2012 (IT) RM2012A000015

(51) Int. Cl. A61C 8/00

(52) U.S. Cl. CPC A61C 8/0083
USPC 433/173

(57) ABSTRACT

Biocompatible material bars adapted to prevent the interdental bone peak resorption following dental procedures and/or periodontal diseases are described. The biocompatible material bars have different shapes, are made out of biocompatible material and have different surface treatments, which avoid the interdental bone peaks resportion following dental procedures and/or periodontal diseases. The bars of biocompatible material are thin and likewise small-sized in length and width in order to fit the interdental bone size. The bars may have different shapes which make them suitable to be completely inserted into the interdental home, thus matching its shape and size without portions external to the bone. The bars may have surface treatments which favour their implantation and osseointegration.

### PRIOR ART

The aesthetically pleasant appearance of a natural set of teeth or of a set of teeth reconstructed with dental prosthesis is due also to the harmony existing between the gingival component (soft tissues or gingiva) and the dental component (teeth).

The relationship between these two components in an oral health condition, which then corresponds to the aesthetically most captivating condition, provides for the presence of gingival extensions or prolongations between teeth.

Interdental extensions, also referred to as interdental papillae, give a scalloped appearance to the gingival component.

Normally, in conditions of periodontal health, i.e. health of the tooth supporting tissues—gingiva, bone and periodontal ligament—the interdental papillae's tip extents up to the contact point between adjacent teeth, thus completely closing the interdental space. The lack of interdental papillae in a smile is often a sign of a pathological condition, such as an inflammation of soft and hard tissues or of the alveolar bone, and it causes the appearance of black triangles between teeth.

Besides defacing the smile from an aesthetic point of view, black interdental triangles cause several inconveniences to the patient, such as:
Stagnation of food residues and dental plaque at interdental spaces
Altered speech due to air passage through open interdental spaces
Passage of saliva through interdental spaces during phonation.

The gingiva and interdental papillae do not have a shape of their own, but they assume the shape and configuration of the underlying bone which they cover.

Therefore, for a gingiva's scalloped appearance to be present, i.e. presence of interdental papillae, it is necessary for the underlying bone to have a scalloped appearance as well, in other words it needs to have interdental bone peaks.

When in pathological situations such as periodontal disease or periodontitis, or following iatrogenic procedures such as periodontal surgery, the bone resorbs, loses its scalloping, flattens and shrinks, also the gingiva flattens and shrinks, thus losing its interdental scalloping and therefore its papillae.

The flattening and shrinkage of the gingiva, and the loss of its scalloping, causes teeth to appear longer than usual, dental roots to be exposed, and black interdental triangles to appear.

Interdental papillae height determinants are mainly two:
Lateral compression exerted on the gingiva by two teeth adjacent to the papilla
Bone peaks below interdental papillae.

Between the two height determinants , the underlying bone plays an essential role, so it is important to try to prevent the iatrogenic resorption of interdental bone peaks which may occur following dental procedures such as:
Dental extraction
Replacement of missing teeth by inserting (single or multiple) dental implants
Periodontal surgery

Currently, there are no clinical and scientific effective and repeatable techniques for preserving interdental bone peaks and therefore the papillae, although particular emphasis is given to this topic in both scientific publications and oral communications presented at national and international conferences.

Instead, devices for the reconstruction of bone peaks, and therefore of papillae, previously resorbed, i.e. lost, have been described.

Particularly, the patent US 2010/0248185 (D1) owned by Ricardo Hermellino LEITE and deposited on Sept 30, 2010 describes a “dental pin”, characterized by a head external to the bone which is anchored by a body inserted into the bone. The head replaces the previously resorbed bone peak and functions as a support to gingival soft tissues so as to form a new papilla.

The patent WO 2011/059738 A1 (D2) owned by Darnell KAIGLER and deposited on May 19, 2011 describes an “embodiment” or implant, also characterized by a body with the function of anchorage inside the bone and by a head external to the bone with acting as an artificial bone peak on which the previously lost papilla must rest and regrow.

The patent US 2009/0061386 A1 owned by Tetsuya NISHIDA deposited on Mar. 5, 2009 describes an “implanter” or implant, characterized by an intraosseous part or body with a function of anchorage for a projection external to the alveolar bone which reproduces a previously destroyed bone peak.

The patent U.S. Pat. No. 6,213,774 B1 owned by Sargon Lazarof deposited on Apr. 10, 2001 describes an implant for dental papillae, characterized by a shaft to be inserted into the bone connected to a head external to the bone for supporting the previously destroyed papilla.

Therefore, all aforementioned patents call for the positioning of prostheses replacing bone peaks (papilla dental implant; implanter; dental pin;) which are all similar to one another and characterized by having a part external to the bone (head) and an intraosseous part (body) necessary only to anchor the head. Such devices are not used to prevent interdental bone peak resorption but only for the restoration or recovery of the interdental bone crest previously destroyed. Therefore, they do not have a function of prevention, but rather of recovery or replacement, and thus they represent a type of a late or delayed therapy, in the form of a prosthesis which, according to the definition, is “. . . an artificial apparatus used to replace a missing part of the body, such as a limb, an eye, a heart valve . . . ” or, as in this case, an interdental papilla.

All aforementioned devices have been designed to be inserted only into the point where the bone crest is already flattened and the bone peaks have already undergone a resorption process and therefore must be reconstructed (restoration), but such devices cannot be used where the original (natural) bone peaks are still intact.

In fact, despite being capable of having sections of different shape and dimensions, the external heads, which represent the core of their inventive concept, must remain outside the bone to reconstruct the resorbed bone peak, and they cannot be pushed into the peaks because of their shape and dimensions.

Instead, as regards to preservation of papillae and therefore to prevention of their resorption, surgical techniques for preservation or regeneration of papillae have been suggested over time such as the “papilla preservation flap” technique, wherein the papilla is not subject to incision first, and to dissection then, during surgery; or the meticulous preservation of bone peaks by means of procedures that are as atraumatic as possible such as, for example, dental extractions performed through luxation exerted only on palatal or lingual area without affecting or touching interdental bone peaks and papillae with the lever; yet others suggest not to involve papillae, when possible, during clinical procedures so as not to create undesired resorptions, or to rotate portions of the gingival flap in an interproximal direction so as to recreate flattened papillae after surgical procedures concerning the insertion of intraosseous implants (Palacci).

None of these suggestions and none of these techniques allow to achieve appreciable, repeatable, stable and durable results.

The replacement of a missing tooth by an titanium dental implant, i.e. an artificial root which replaces the root of an extracted natural tooth, is a successful technique which is made possible by the high compatibility of pure titanium and alloys thereof with the bone tissue.

Once it has been surgically inserted, the implant and the bone establish an indirect and strong contact through titanium oxides over the months.

This process, referred to as “osseointegration”, gives stability to the implant which can be reconstructed with an artificial prosthesis (crown or capsule).

The use of dental implants made out of titanium or alloys thereof has highlighted that such application not only allows to insert new artificial teeth anchored to the bone, but also prevents a further bone resorption over time where the implant has been inserted. According to the present invention, starting from this feature of titanium and alloys thereof, “bars” have been designed which, once inserted into the interdental bone thickness, prevent the bone peak resorption.

### DESCRIPTION OF THE INVENTION

The object of the present invention is to provide “bars” of biocompatible material having a size, a shape and surfaces which make them suitable to be inserted into the interdental bone peaks.

Said bars of biocompatible material are inserted into the interdental bone thickness according to a technique which will be herein described.

According to the present invention, bars of biocompatible material are fabricated having such a size to fit the interdental bone dimensions, and therefore these bars are thin in thickness and likewise small-sized in length and width.

Bars may have different shapes which make them suitable to be inserted into the interdental bone, thus matching its shape and size, and they may have surface treatments which favor their implantation and osseointegration.

The method for surgically inserting bars of biocompatible material into the interdental bone thickness provides that this insertion occurs before, or in some cases at the same time of, performing dental procedures, thus forming a site in the interdental bone into which the bar is implanted or inserted.

After implantation, the bar can be covered with a filler material (such as bone, hydroxyapatite, etc.) and by a resorbable membrane.

### DESCRIPTION OF THE DRAWINGS

The invention is set forth hereinafter with reference to the drawings which show an exemplary but not limiting bar, wherein:

FIG. 1 shows a bar with a square cross section

FIG. 2 shows a bar with an oval cross section

FIG. 3 shows a bar with a rectangular cross section

FIG. 4 shows a bar with a bilobate cross section

FIG. 5 shows a bar with an hourglass-shaped cross section

FIG. 6 shows a bar with a lenticular cross section

FIG. 7 shows a bar with a round cross section

FIG. 8 shows a rectangular bar with a solid body

FIG. 9 shows a rectangular bar with a hollow body

FIG. 10 shows an hourglass-shaped bar with two holes at the ends

FIG. 11 shows a lenticular bar

FIG. 12 shows a rectangular bar with serrated sides or profiles

FIG. 13 shows a rectangular bar with a series of holes on the surface

FIG. 14 shows a rectangular bar with a series of oval openings on the surface

FIG. 15 shows a bar with an hourglass-shaped profile

FIG. 16 shows a lenticular bar with a series of holes on the surface

FIG. 17 shows a situation of bars' insertion before a tooth extraction

FIG. 17a shows a situation of interdental papillae after a certain period of time following the bars' insertion and after the tooth extraction.

FIG. 17b shows a situation of interdental papillae with bars after seating an artificial tooth (crown) on an intraosseous implant.

Plate 18 shows the sequence of FIGS. 17 to 17b in the situation where two artificial teeth (crowns) are seated on two adjacent dental implants.

Plate 19 shows the sequence of FIGS. 17 to 17b in the situation where two artificial teeth are inserted as bridge intermediary elements (pontics) between two natural teeth functioning as abutments or pillars.

FIG. 20 shows an exemplary view of biocompatible material bars of the present invention implanted into interdental bone peaks.

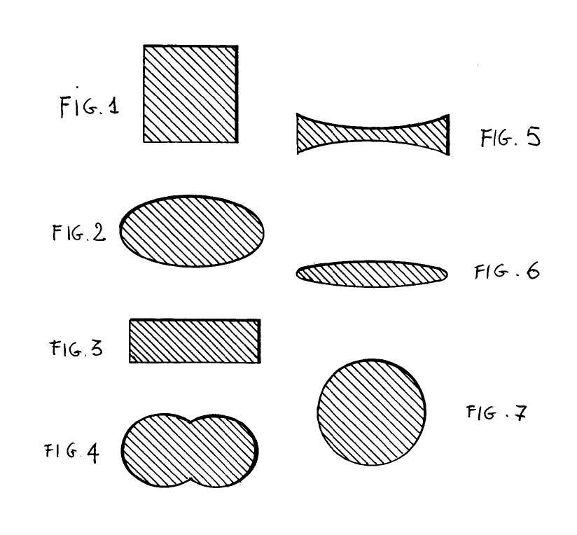

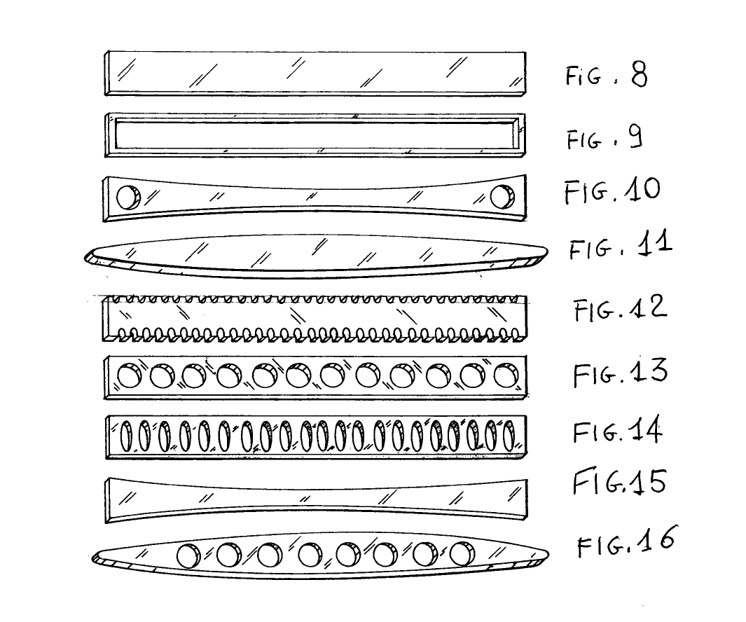

### DESCRIPTION OF A PREFERRED EMBODIMENT

An essential element of the present invention is the presence of a bar, such as the biocompatible material bar (1) which, as mentioned, may have different shapes, profiles, dimensions and sections as long as they are compatible with those of the interdental bone into which the bar has to be implanted or inserted.

The biocompatible material bar is made out of a biocompatible material, such as titanium or alloys thereof, and alternatively it may be made out of all materials suitable to prevent over time the bone resorption such as, inter alia, titanium alloys, ceramic, carbonium.

The surface of the biocompatible material bar may be smooth or, if necessary, treated in various manners and with various techniques so as to stimulate and/or promote the osseointegration process and increase the surface contacting the bone.

Surface treatments of the biocompatible material bar have been tested with good results such as but not only:

Acid etching of the surface

Plasma sprayed surfaces

hydroxyapatite (HA) coatings

sandblasting of the surface

roughening of the surface.

All these surface treatments are specific of and referable to several manufacturers of dental implants and they are all applied for the same purposes, i.e. increasing the contact surface between bone and implant, and promoting the osseointegration process.

From the performed experiments, it has been found that a bar (1) in the shape of an elongate rectangular parallelepiped of the type shown in FIG. 8 having average dimensions of 1 mm in thickness or height, 0.7 mm in width and 5 mm in length allows to obtain the desired results; of course, bar dimensions may vary based on the dimensions of interdental peaks' bone.

The bar (1) made out of biocompatible material may have, as mentioned, shapes different from the rectangular shape so as to fit at its best the shape and dimension of the interdental bone and interdental papillae.

Among the shapes of the bar (1) which are shown herein, the lenticular section, for example, allows for an insertion into narrow bone peaks, thus preserving a greater amount of interproximal bone.

Within the different shapes of the bar (1), the surfaces may be perforated or hollow so as to allow the bone to grow both outside of and inside the bar to increase both the stability and the contact surface.

Also the bar edges can be smooth or undulated or serrated, and each conformation allows to make the bar particularly suitable to be implanted in specific situations; for example, a sharp serration allows for a deeper insertion and a greater primary stability thanks to the cutting action exerted by the bar's profile on the bone.

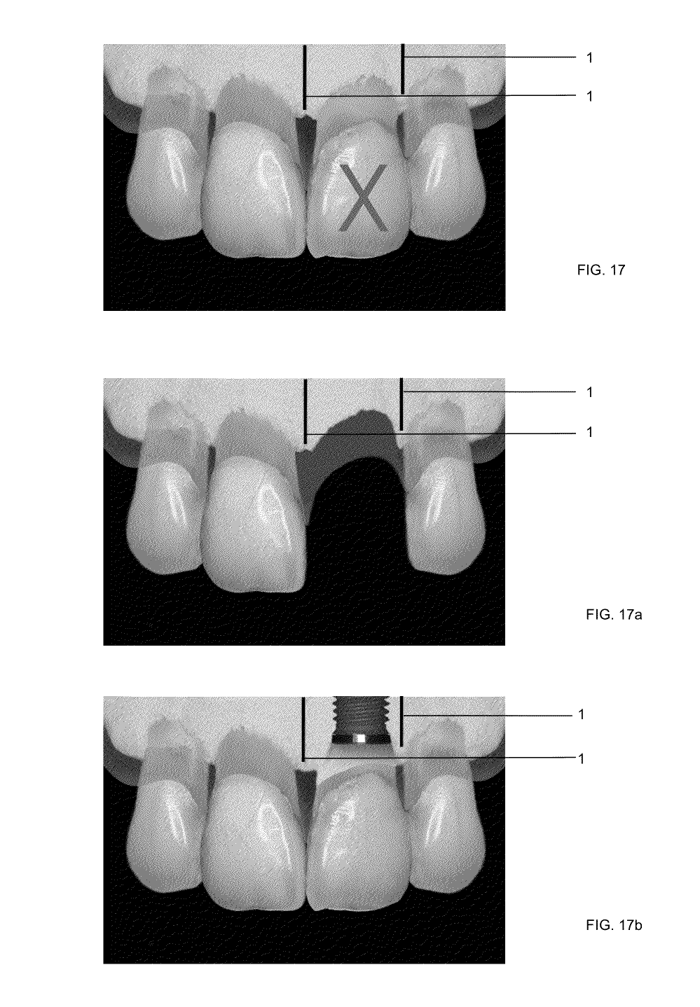

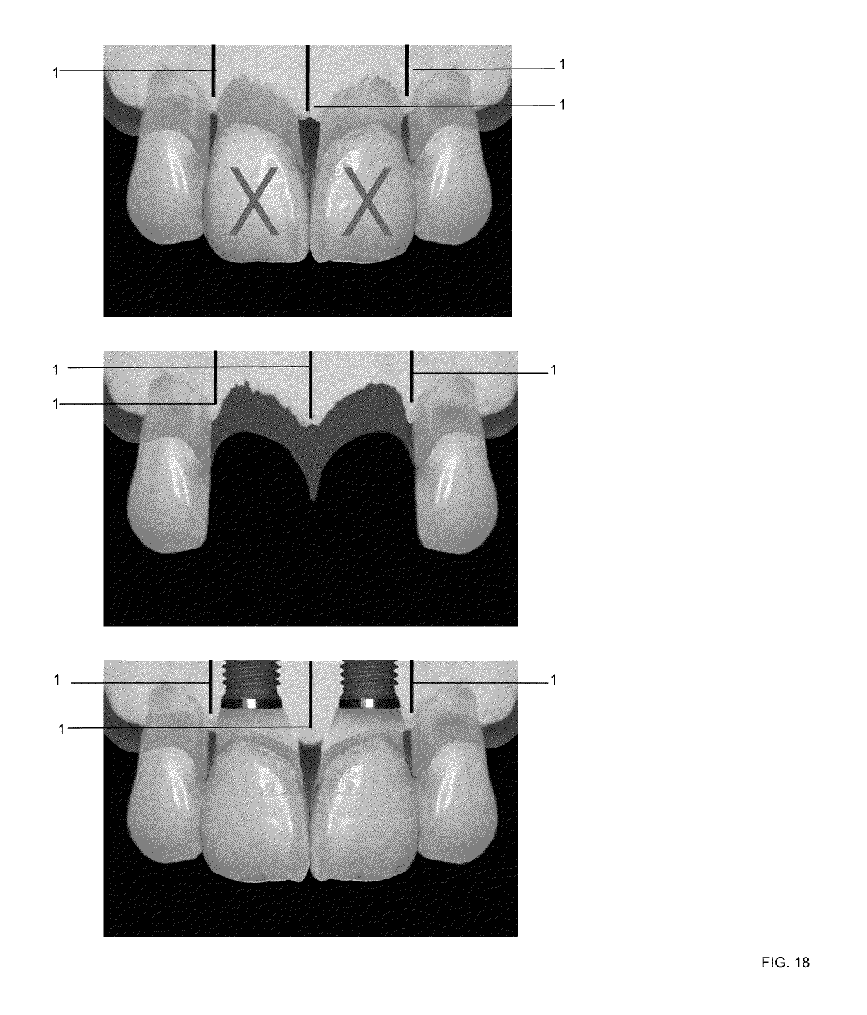

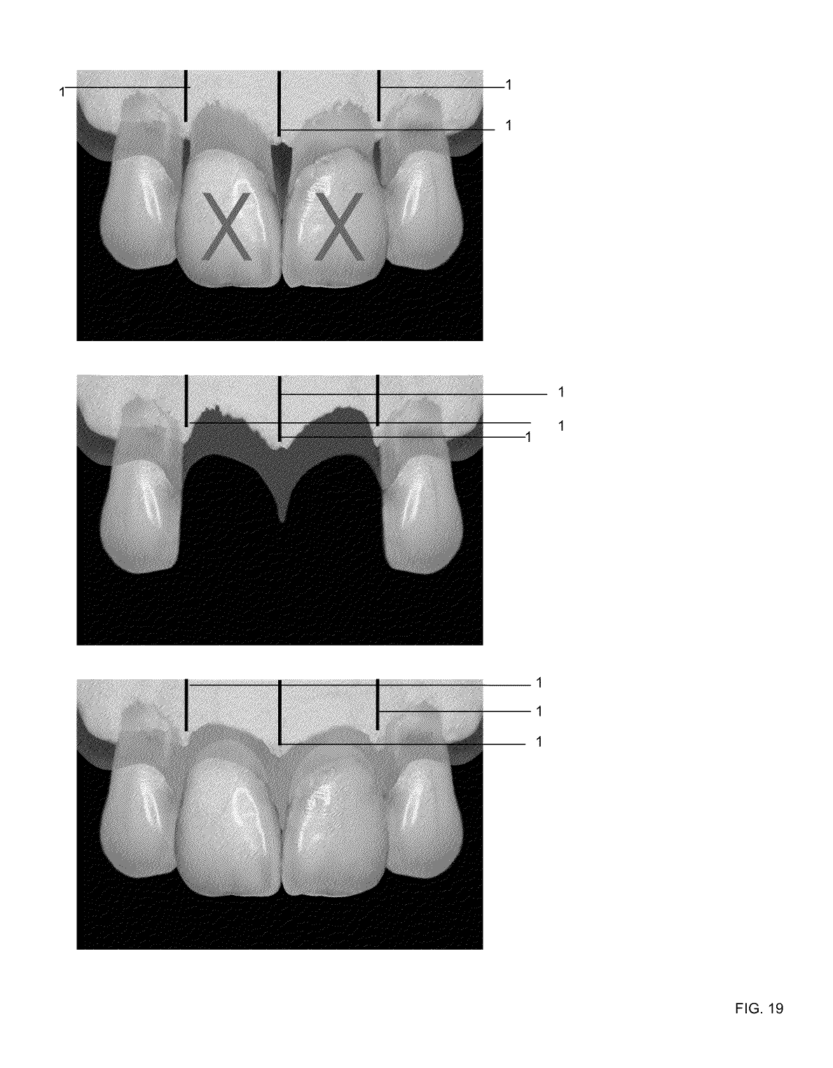

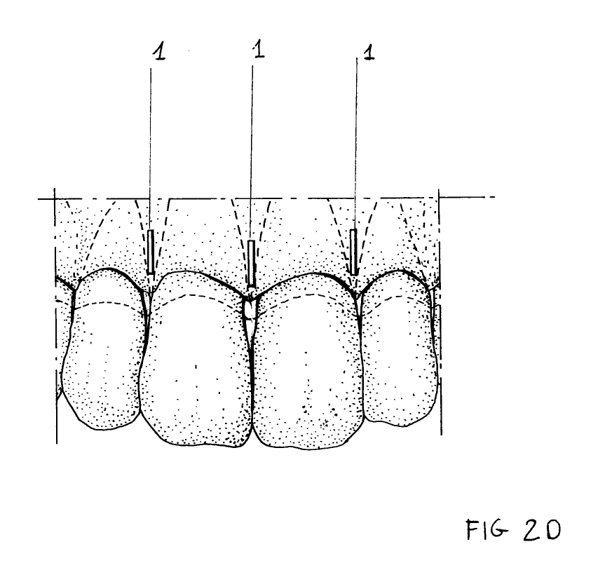

The insertion of biocompatible material bars (1) into the interdental bone, as schematically shown in FIGS. 17, 17a and 17b as well as in plates 18 and 19, before or at the same time of performing dental procedures, comprises of the following steps:
Incising and dissecting a full-thickness or envelope flap for denudation of interdental bone peaks;
Developing an appropriate site, by means of an osteotomy bur for piezoelectric surgical unit which is calibrated with the same dimensions and shapes of the biocompatible material bar to be implanted or inserted, at the point of the interdental bone into which the biocompatible material bar has to be implanted;
Checking the osteotomy dimension by means of a special caliper;
Placing the biocompatible bar to be implanted;
Deeply inserting the biocompatible material bar into the osteotomy site by means of a special instrument having an extremity made out of steel or titanium or Teflon or any other suitable material, and a hammer having a head made of steel or Teflon or any other suitable material;
Covering the biocompatible material bars, and—if used—the filler material, with resorbable collagen membranes having a size and shape compatible with the performed osteotomy;
Suturing the flap;
Waiting the time necessary for the osseointegration of biocompatible material bars which will preserve the interdental bone peak's original height over time;
Performing programmed dental procedures (dental extraction or other).

1. Biocompatible material bars adapted to prevent interdental bone peak resorption following dental procedures comprising elements made out of said material,
wherein:
said elements have small thickness, small length and width and therefore dimensions configured to allow for a complete and total insertion of said biocompatible material elements into an interdental bone thickness, and
said elements are without portions adapted to function as an element external to the bone or head and/or as a direct support for gingival soft tissues.

2. The biocompatible material bars according to claim 1, wherein said elements of biocompatible material have the shape of an elongated rectangular parallelepiped.

3. The biocompatible material bars according to claim 1, wherein said elements of biocompatible material are rectangular shaped and are 0.7 mm wide, 1 mm thick or high and 5 mm long.

4. The biocompatible material bars according to claim 1, wherein said elements of biocompatible material have a square cross section.

5. The biocompatible material bars according to claim 1, wherein said elements of biocompatible material have a round cross section.

6. The biocompatible material bars according to claim 1, wherein said elements of biocompatible material have a lenticular cross section.

7. The biocompatible material bars according to claim 1, wherein said elements of biocompatible material have an oval cross section.

8. The biocompatible material bars according to claim 1, wherein said elements of biocompatible material have an hourglass-shaped cross section.

9. The biocompatible material bars according to claim 1, wherein said elements of biocompatible material have a bilobate cross section.

10. The biocompatible material bars according to claim 1, wherein said elements of biocompatible material have a solid body.

11. The biocompatible material bars according to claim 1, wherein said elements of biocompatible material have a body with hollow areas.

12. The biocompatible material bars according to claim 1, wherein said elements of biocompatible material have smooth edges.

13. The biocompatible material bars according to claim 1, wherein said elements of biocompatible material have serrated and/or undulated edges.

14. The biocompatible material bars according to claim 1, wherein said elements of biocompatible material have an outer smooth surface.

15. The biocompatible material bars according to claim 1, wherein said elements of biocompatible material have a chemically and/or physically treated outer surface.

16. The biocompatible material bars according to claim 1, wherein said elements of biocompatible material have an outer surface which is roughened with physical and/or chemical treatments.

17. A method for prevent the iatrogenic resorption of interdental bone peaks following dental procedures and/or periodontal diseases comprising a step of inserting completely into the interdental bone thickness a biocompatible material bar according to claim 1.

18. The method according to claim 17, comprising the following steps:
incising and dissecting a full-thickness or envelope flap for denudation of interdental bone peaks;
developing an appropriate site at the point of the interdental bone into which the biocompatible material bar according to claim 1 has to be implanted;
checking the osteotomy dimension by means of a special caliper;
deeply inserting the biocompatible material bar according to claim 1 into the osteotomy site;
covering the biocompatible material bars, with resorbable collagen membranes having a size and shape compatible with the performed osteotomy;
suturing the flap,
waiting the time necessary for the osseointegration of biocompatible material bars which will preserve the interdental bone peak's original height over time; and
performing programmed dental procedures.
